(19) United States
(12) Patent Application Publication
(10) Pub. No.: US 2026/0319419 A1
(43) Pub. Date: Oct. 15, 2026

(54) SHEET FEEDING APPARATUS AND IMAGE FORMING APPARATUS

(71) Applicant: CANON KABUSHIKI KAISHA, Tokyo (JP)

(72) Inventors: KOUYOU TAMURA, Chiba (JP); HAJIME SEKIGUCHI, Chiba (JP); SEIYA FUJIYAMA, Chiba (JP)

(21) Appl. No.: 19/465,425

(22) Filed: Jan. 30, 2026

(30) Foreign Application Priority Data
Feb. 18, 2025 (JP) 2025-024123

(51) Int. Cl. G03G 15/00

(52) U.S. Cl. CPC G03G 15/6502; G03G 2215/00679

(57) ABSTRACT

A sheet feeding apparatus includes an apparatus body, a first storage unit, and a second storage unit, the second storage unit being arranged side by side with the first storage unit in a second direction orthogonal to the first direction. The frame body includes a first frame disposed on a side of the first storage unit that is opposite to the second storage unit in the second direction, and a second frame disposed on a side of the second storage unit that is opposite to the first storage unit in the second direction. The first storage unit includes a first abutment portion configured to abut on the first frame in the first direction at the first mounting position. The second storage unit includes a second abutment portion configured to abut on the second frame in the first direction at the second mounting position.

### BACKGROUND

### Field of the Technology

The present disclosure relates to a sheet feeding apparatus that feeds a sheet, and an image forming apparatus.

### Description of the Related Art

For example, there has been proposed an image forming apparatus in which two decks (sheet storage tray) that can be pulled out in a front-rear direction are arranged side by side in a left-right direction in order to supply a large amount of small-sized sheets (see JP H09-20434 A).

In a case where positioning accuracy of the sheet storage tray as described above when mounted on an apparatus body is not satisfactory, for example, skew feeding of the sheet or misalignment during image formation may be caused.

### SUMMARY

According to one aspect of the present disclosure, a sheet feeding apparatus includes an apparatus body including a first feeding unit configured to feed a sheet, a second feeding unit configured to feed a sheet, and a frame body, a first storage unit configured to store the sheet to be fed by the first feeding unit and move in a first direction between a first mounting position where the first storage unit is mounted on the apparatus body and a first separation position where the first storage unit is separated from the apparatus body, and a second storage unit configured to store the sheet to be fed by the second feeding unit and move in the first direction between a second mounting position where the second storage unit is mounted on the apparatus body and a second separation position where the second storage unit is separated from the apparatus body, the second storage unit being arranged side by side with the first storage unit in a second direction orthogonal to the first direction. The frame body includes a first frame disposed on a side of the first storage unit that is opposite to the second storage unit in the second direction and disposed with a third direction orthogonal to the first direction and the second direction as a longitudinal direction thereof, and a second frame disposed on a side of the second storage unit that is opposite to the first storage unit in the second direction and disposed with the third direction as a longitudinal direction thereof. The first storage unit includes a first abutment portion configured to abut on the first frame in the first direction at the first mounting position. The second storage unit includes a second abutment portion configured to abut on the second frame in the first direction at the second mounting position.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic view of an image forming apparatus according to the present embodiment.

FIG. 2 is a perspective view illustrating a configuration of a frame body according to the present embodiment.

FIG. 3 is a perspective view illustrating a right feeding cassette according to the present embodiment when viewed from a right-rear side.

FIG. 4 is a perspective view illustrating a state in which the right feeding cassette according to the present embodiment is mounted on an apparatus body when viewed from a right-front side.

FIG. 5 is a perspective view illustrating a left feeding cassette according to the present embodiment when viewed from the right-rear side.

FIG. 6 is a perspective view illustrating the left feeding cassette according to the present embodiment when viewed from a left-front side.

FIG. 7 is a perspective view illustrating a state in which the left feeding cassette according to the present embodiment is mounted on the apparatus body when viewed from the left-front side.

FIG. 8 is a perspective view illustrating a positioning pin of the left feeding cassette according to the present embodiment when viewed from the right-front side.

FIG. 9 is a perspective view illustrating a lower feeding cassette according to the present embodiment when viewed from the right-rear side.

### DESCRIPTION OF THE EMBODIMENTS

Hereinafter, a sheet feeding apparatus and an image forming apparatus according to the present embodiment will be described with reference to the drawings.

### Overall Configuration of Printer

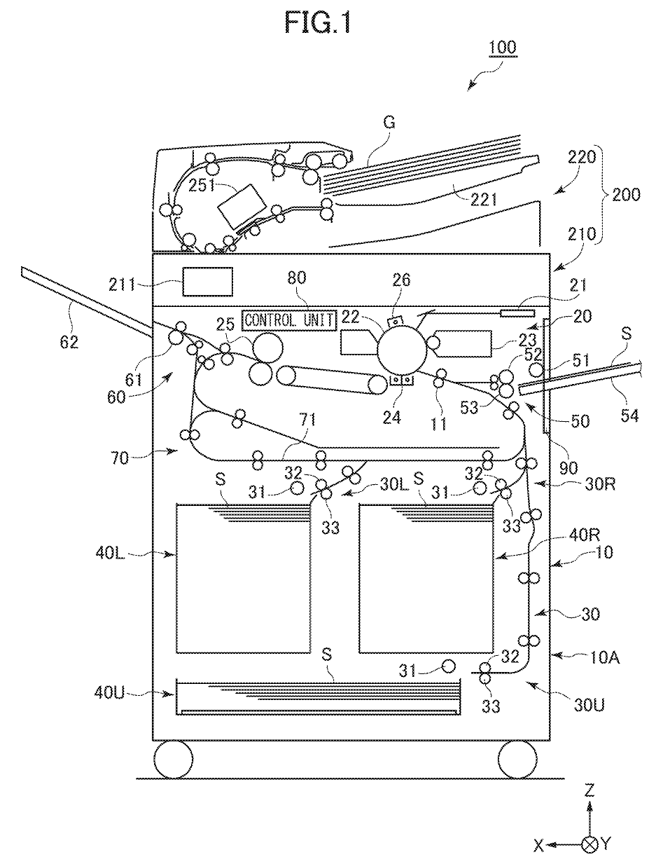

First, a configuration of a printer 100, which is the image forming apparatus according to the present embodiment, will be described with reference to FIG. 1. FIG. 1 is a schematic view of the image forming apparatus according to the present embodiment. In the present embodiment, a direction in which an operation panel (not illustrated) included in the printer 100 is generally directed is referred to as a front side, and a side opposite to the front side is referred to as a rear side. That is, an attachment/detachment direction of a cassette described later is referred to as a front-rear direction Y serving as a first direction. A direction orthogonal to the front-rear direction Y is referred to as a left-right direction X serving as a second direction. Further, a direction orthogonal to the front-rear direction Y and the left-right direction X is referred to as a top-bottom direction Z serving as a third direction. In the present embodiment, the front-rear direction Y and the left-right direction X are horizontal directions. However, the front-rear direction Y and the left-right direction X may be inclined depending on an installation status of the printer 100 or the like.

As illustrated in FIG. 1, the printer 100 includes an image reading apparatus 200 that can read an image of a document G supported by a document support tray 221, and an apparatus body 10 that can form the image read by the image reading apparatus 200 on a sheet S. The printer 100 further includes a control unit 80 that controls the image reading apparatus 200 and the apparatus body 10. The printer 100 illustrated in FIG. 1 is an electrophotographic laser beam printer, and may be a printer using an inkjet method or another image forming method as an image forming unit.

The image reading apparatus 200 includes a reading unit 210 including a first reader 211 that reads an image on a front surface (first surface) of the document G, and an automatic document feeder (hereinafter referred to as “ADF”) 220 that can automatically feed the document G to the first reader 211. In addition, the ADF 220 includes a second reader 251 that reads an image on a back surface (a second surface opposite to the first surface) of the document G. The first reader 211 is a reader used at the time of feeding-reading of the front surface of the document G or at the time of fixed-reading of the document set on a glass plate (not illustrated) of the reading unit 210. The second reader 251 is a reader that reads the back surface at the time of the feeding-reading of the document G.

The apparatus body 10 includes an image forming unit 20 that forms an image on the sheet S, a sheet storage unit 40 that stores and supports a plurality of sheets S, and a sheet feeding unit 30 serving as the sheet feeding apparatus that feeds the sheet S stored in the sheet storage unit 40 to the image forming unit 20. In addition, the apparatus body 10 includes a manual feeding unit 50 that feeds the sheet S supported by a manual feed tray 4 to the image forming unit 20. The apparatus body 10 includes a sheet discharge unit 60 that discharges the sheet S on which the image is formed by the image forming unit 20, and a re-conveyance unit 70 that re-conveys the sheet S on which the image is formed by the image forming unit 20 to the image forming unit 20 again.

In the present embodiment, the sheet storage unit 40 includes a right feeding cassette 40R serving as a first storage unit, a left feeding cassette 40L serving as a second storage unit, and a lower feeding cassette 40U serving as a third storage unit. The right feeding cassette 40R and the left feeding cassette 40L are arranged side by side in the left-right direction X, and the lower feeding cassette 40U is arranged below (in the top-bottom direction Z) the right feeding cassette 40R and the left feeding cassette 40L.

The sheet feeding unit 30 includes a right sheet feeding unit 30R serving as a first feeding unit, a left sheet feeding unit 30L serving as a second feeding unit, and a lower sheet feeding unit 30U serving as a third feeding unit. The respective sheet feeding units have the same configuration, and for example, the right sheet feeding unit 30R includes a pickup roller 31 that picks up the sheet S, and a feed roller 32 and a retard roller 33 that separate the sheets S one by one. The right sheet feeding unit 30R feeds the uppermost sheet among the sheets S supported by the right feeding cassette 40R. Similarly, the left sheet feeding unit 30L feeds the uppermost sheet among the sheets S supported by the left feeding cassette 40L. Similarly, the lower sheet feeding unit 30U feeds the uppermost sheet among the sheets S supported by the lower feeding cassette 40U.

In addition, the manual feeding unit 50 includes a manual feed tray 54, a pickup roller 51 that picks up the uppermost sheet among the sheets S supported by the manual feed tray 54, and a feed roller 52 and a retard roller 53 that separate the sheets S one by one. That is, the manual feeding unit 50 feeds the uppermost sheet among the sheet S supported by the manual feed tray 54. The apparatus body 10 is provided with a door 90 for accessing the inside of the apparatus body 10 so that the jammed sheet S can be removed and a consumable part in the apparatus body 10 can be replaced.

The image forming unit 20 includes a photosensitive drum 22 on which a toner image is formed, a laser scanner unit 21 that irradiates the photosensitive drum 22 with laser light, a transfer unit 24 that transfers the toner image to the sheet S, and a fixing unit 25 that fixes the toner image. A registration roller pair 11 is disposed at a position upstream of the transfer unit 24 in a conveyance path for conveying the sheet S.

The sheet discharge unit 60 includes a discharge roller pair 61 that discharges the sheet S conveyed from the fixing unit 25 to a sheet discharge tray 62. In addition, the re-conveyance unit 70 reverses a conveyance direction of the sheet S conveyed from the fixing unit 25, and re-conveys the reversed sheet S to the image forming unit 20 via a re-conveyance path 71. As a result, the sheet S is flipped, and the image forming unit 20 forms an image on the back side of the sheet S, that is, double-sided printing can be performed.

### Operation of Printer

Next, an image forming operation of the printer 100 will be described. Here, a case where an image is formed on the sheet S fed from any one cassette of the sheet feeding unit 30 based on image information of the document G read by the image reading apparatus 200 will be described as an example. The photosensitive drum 22 is irradiated with the laser light from the laser scanner unit 21 based on the image information of the document G read by the image reading apparatus 200. At this time, the photosensitive drum 22 is charged in advance via a charging member 26. When the charged photosensitive drum 22 is irradiated with the laser light, an electrostatic latent image is formed on a surface of the photosensitive drum 22. Further, the formed electrostatic latent image is developed by a developing device 23 and formed as the toner image on the photosensitive drum 22.

In parallel with an operation of forming the toner image on the photosensitive drum 22, feeding of the sheet S supported by any one cassette of the sheet storage unit 40 is started by the pickup roller 31 of the sheet feeding unit 30 corresponding to the cassette. The sheet S fed by the pickup roller 31 is nipped by a separation nip between the feed roller 32 and the retard roller 33, so that the sheets S are separated and conveyed one by one. Each separated sheet S is synchronized with the toner image on the photosensitive drum 22 by the registration roller pair 11 and is sent to the transfer unit 24.

The transfer unit 24 transfers, to the sheet S, the toner image on the photosensitive drum 22 synchronized with each separated sheet S sent from the separation nip. The sheet S to which the toner image has been transferred by the transfer unit 24 is heated and pressurized by the fixing unit 25. The toner image transferred to the heated and pressurized sheet S is fixed to the sheet S by the heating and pressurization. The sheet S to which the toner image is fixed is discharged to the sheet discharge tray 62 by the discharge roller pair 61, and is sequentially stacked. In a case where images are formed on both sides of the sheet S, after the image is fixed on a first side of the sheet S, the sheet S is re-conveyed toward the registration roller pair 11 via the re-conveyance path 71, and the above-described operation is repeatedly performed.

### Configuration of Frame Body

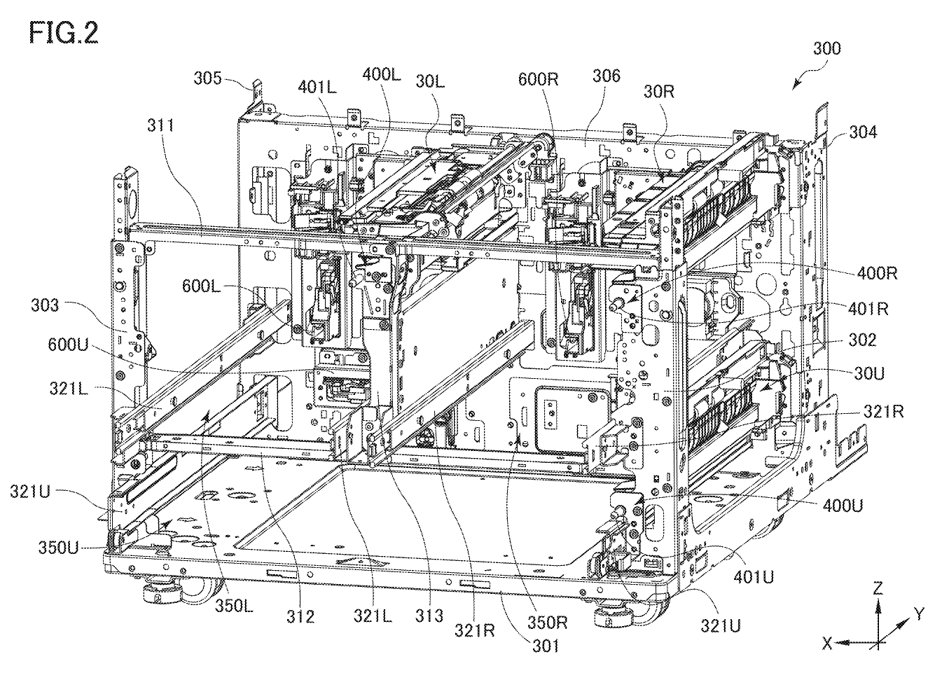

Next, a configuration of a frame body 300 that supports various components included in the apparatus body 10 of the printer 100 will be described with reference to FIG. 2. FIG. 2 is a perspective view illustrating a configuration of the frame body according to the present embodiment.

As illustrated in FIG. 1, the sheet feeding unit 30 includes a feeding apparatus body 10A serving as an apparatus body including the right sheet feeding unit 30R, the left sheet feeding unit 30L, and the lower sheet feeding unit 30U, which feed the sheet, and the frame body 300 (see FIG. 2). The feeding apparatus body 10A of the sheet feeding unit 30 can be said to be a part of the apparatus body 10 of the printer 100.

As illustrated in FIG. 2, the frame body 300 includes a lower plate 301, a right-front frame 302 serving as a first frame, a left-front frame 303 serving as a second frame, a right-rear frame 304, a left-rear frame 305, and a rear plate 306. That is, the right-front frame 302 and the left-front frame 303 are fixedly disposed at both ends (one side and the other side) on a front side of the lower plate 301 in the left-right direction X, with the top-bottom direction Z as a longitudinal direction. In addition, the right-rear frame 304 and the left-rear frame 305 are fixedly disposed at both ends on a rear side of the lower plate 301 in the left-right direction X, with the top-bottom direction Z as a longitudinal direction. The rear plate 306 is fixedly disposed on the right-rear frame 304 and the left-rear frame 305, with a plane direction defined by the left-right direction X and the top-bottom direction Z.

The frame body 300 includes an upper-front stay 311 serving as a first reinforcing member or a first cross member, a lower-front stay 312 serving as a second reinforcing member or a second cross member, and an intermediate stay 313 serving as a third reinforcing member or a support member, the upper-front stay 311, the lower-front stay 312, and the intermediate stay 313 being positioned between the right-front frame 302 and the left-front frame 303. That is, the upper-front stay 311 spans between upper end portions of the right-front frame 302 and the left-front frame 303 and is fixedly disposed, with the left-right direction X as a longitudinal direction. Further, the lower-front stay 312 spans between lower portions of the right-front frame 302 and the left-front frame 303 below the center and is fixedly disposed, with the left-right direction X as a longitudinal direction. The intermediate stay 313 spans between central portions of the upper-front stay 311 and the lower-front stay 312 and is fixedly disposed, with the top-bottom direction Z as a longitudinal direction.

The frame body 300 as described above forms a right cassette mounting space 350R in which the right feeding cassette 40R is movable between a first mounting position where the right feeding cassette 40R is mounted on the feeding apparatus body 10A (that is, the frame body 300) and a first separation position where the right feeding cassette 40R is separated from the feeding apparatus body 10A. That is, the right cassette mounting space 350R forms an opening between the right-front frame 302 and the intermediate stay 313 in the left-right direction X, and between the upper-front stay 311 and the lower-front stay 312 in the top-bottom direction Z. The right cassette mounting space 350R is a substantially box-shaped space in which the right feeding cassette 40R is mounted by being inserted through the opening to reach the rear plate 306.

In the right cassette mounting space 350R, two guide rails 321R, which respectively span between the right-front frame 302 and the rear plate 306 and between the intermediate stay 313 and the rear plate 306, and guide the right feeding cassette 40R so as to be movable in the front-rear direction Y, are disposed. In addition, a retraction unit 600R serving as a first retractor is disposed on the rear plate 306 positioned on a rear side of the right cassette mounting space 350R. The retraction unit 600R incorporates, for example, a toggle mechanism (not illustrated), is engaged with a retraction guide pin 43R when the right feeding cassette 40R (described below in detail) is moved from the first separation position to the first mounting position, and retracts the right feeding cassette 40R to the first mounting position.

In addition, the frame body 300 forms a left cassette mounting space 350L in which the left feeding cassette 40L is movable between a second mounting position where the left feeding cassette 40L is mounted on the feeding apparatus body 10A (that is, the frame body 300) and a second separation position where the left feeding cassette 40L is separated from the feeding apparatus body 10A. That is, the left cassette mounting space 350L forms an opening between the left-front frame 303 and the intermediate stay 313 in the left-right direction X, and between the upper-front stay 311 and the lower-front stay 312 in the top-bottom direction Z. The left cassette mounting space 350L is a substantially cubic space in which the left feeding cassette 40L is mounted by being inserted through the opening to reach the rear plate 306.

In the left cassette mounting space 350L, two guide rails 321 L, which respectively span between the left-front frame 303 and the rear plate 306 and between the intermediate stay 313 and the rear plate 306, and guide the left feeding cassette 40L so as to be movable in the front-rear direction Y, are disposed. In addition, a retraction unit 600L serving as a second retractor is disposed on the rear plate 306 positioned on a rear side of the left cassette mounting space 350L. Similarly, the retraction unit 600L incorporates, for example, a toggle mechanism (not illustrated), is engaged with a retraction guide pin 43L when the left feeding cassette 40L (described below in detail) is moved from the second separation position to the second mounting position, and retracts the left feeding cassette 40L to the second mounting position.

In addition, the frame body 300 forms a lower cassette mounting space 350U in which the lower feeding cassette 40U is movable between a third mounting position where the lower feeding cassette 40U is mounted on the feeding apparatus body 10A (that is, the frame body 300) and a third separation position where the lower feeding cassette 40U is separated from the feeding apparatus body 10A. That is, the lower cassette mounting space 350U forms an opening between the right-front frame 302 and the left-front frame 303 in the left-right direction X, and between the lower-front stay 312 and the lower plate 301 in the top-bottom direction Z. The lower cassette mounting space 350U is a substantially cubic space in which the lower feeding cassette 40U is mounted by being inserted through the opening to reach the rear plate 306.

In the lower cassette mounting space 350U, two guide rails 321U, which respectively span between the right-front frame 302 and the rear plate 306 and between the left-front frame 303 and the rear plate 306, and guide the lower feeding cassette 40U so as to be movable in the front-rear direction Y, are disposed. A retraction unit 600U serving as a third retractor is disposed on the rear plate 306 on a rear side of the lower cassette mounting space 350U. Similarly, the retraction unit 600U incorporates, for example, a toggle mechanism (not illustrated), is engaged with a retraction guide pin 43U when the lower feeding cassette 40U (described below in detail) is moved from the third separation position to the third mounting position, and retracts the lower feeding cassette 40U to the third mounting position.

In the frame body 300 configured as described above, the right-front frame 302 is disposed on a side (that is, a right side) of the right feeding cassette 40R positioned at the first mounting position, the side being opposite to the left feeding cassette 40L positioned at the second mounting position in the left-right direction X. The left-front frame 303 is disposed on a side (that is, a left side) of the left feeding cassette 40L positioned at the second mounting position, the side being opposite to the right feeding cassette 40R positioned at the first mounting position in the left-right direction X. The upper-front stay 311 is disposed on one sides (that is, upper sides) of the right feeding cassette 40R positioned at the first mounting position and the left feeding cassette 40L positioned at the second mounting position in the top-bottom direction Z. The lower-front stay 312 is disposed on the other sides (that is, lower sides) of the right feeding cassette 40R positioned at the first mounting position and the left feeding cassette 40L positioned at the second mounting position in the top-bottom direction Z. The intermediate stay 313 is disposed between the right feeding cassette 40R positioned at the first mounting position and the left feeding cassette 40L positioned at the second mounting position in the left-right direction X.

### Disposition of Each Sheet Conveyance Unit with Respect to Frame Body

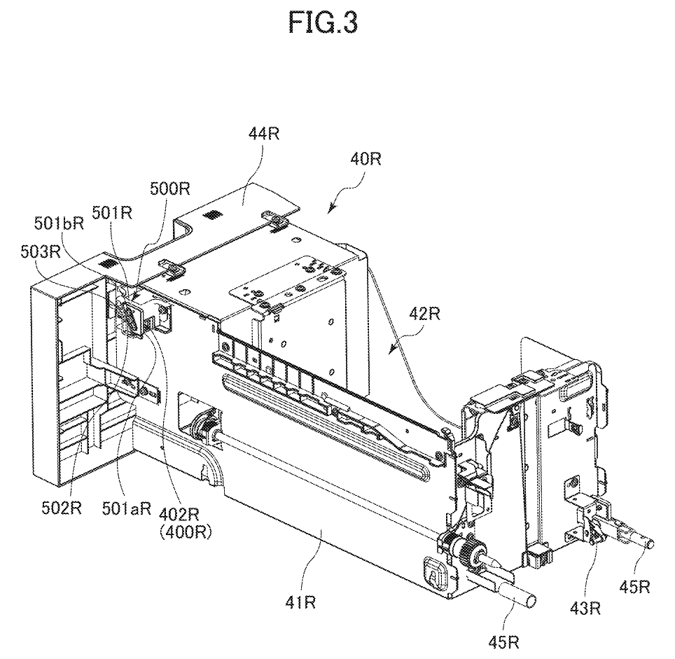

Next, disposition of each sheet conveyance unit with respect to the frame body 300 will be described. As illustrated in FIG. 3, the right sheet feeding unit 30R that feeds the sheet S supported by the right feeding cassette 40R is fixedly supported between the right-front frame 302 and the rear plate 306. That is, the right sheet feeding unit 30R is positioned and supported by the right-front frame 302. The left sheet feeding unit 30L that feeds the sheet S supported by the left feeding cassette 40L is fixedly supported between the left-front frame 303 and the rear plate 306. That is, the left sheet feeding unit 30L is positioned and supported by the left-front frame 303. The lower sheet feeding unit 30U that feeds the sheet S supported by the lower feeding cassette 40U is fixedly supported between the right-front frame 302 and the rear plate 306. That is, the lower sheet feeding unit 30U is positioned and supported by the right-front frame 302.

### Configuration of Right Feeding Cassette

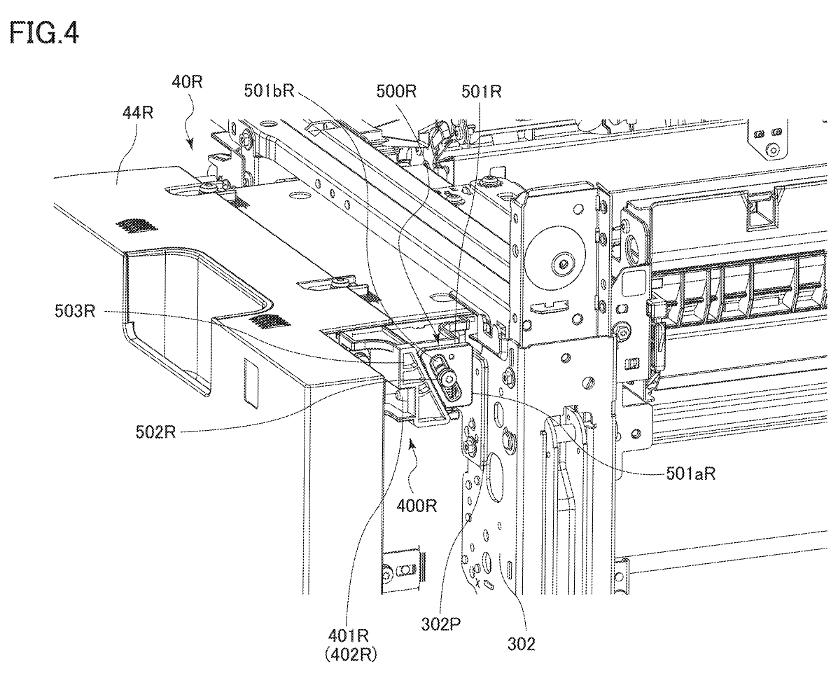

Next, a configuration of the right feeding cassette 40R will be described in detail with reference to FIGS. 3 and 4. FIG. 3 is a perspective view illustrating the right feeding cassette according to the present embodiment when viewed from a right-rear side. FIG. 4 is a perspective view illustrating a state in which the right feeding cassette according to the present embodiment is mounted on the apparatus body when viewed from a right-front side.

As illustrated in FIG. 3, the right feeding cassette 40R includes a main body 41R that forms a storage space 42R in which the sheets S are supported. An outer wall portion 44R that forms a part of an outer wall of the printer 100 is fixedly disposed on a front side of the main body 41R in a state in which the right feeding cassette 40R is positioned at the first mounting position and mounted on the feeding apparatus body 10A. The retraction guide pin 43R that is engaged with the retraction unit 600R to retract the right feeding cassette 40R to the feeding apparatus body 10A when the right feeding cassette 40R is moved from the first separation position to the first mounting position is fixedly disposed on a rear side of the main body 41R. Two insertion shafts 45R that are inserted into holes (not illustrated) of the rear plate 306 of the frame body 300 and support the right feeding cassette 40R are fixedly disposed on the rear side of the main body 41R.

A fitting hole 402R serving as a first engaged portion or a first fitting hole is fixedly disposed on a right side of the main body 41R of the right feeding cassette 40R. A positioning pin 401R (see FIG. 2) serving as a first engaging portion or a first pin fixedly disposed on the right-front frame 302 of the frame body 300 can freely be fitted into the fitting hole 402R. That is, as illustrated in FIG. 4, the positioning pin 401R is fitted into the fitting hole 402R when the right feeding cassette 40R is positioned at the first mounting position and mounted on the feeding apparatus body 10A. As a result, the right feeding cassette 40R is positioned with respect to the right-front frame 302 in the left-right direction X and the top-bottom direction Z, and is positioned with high accuracy in the left-right direction X and the top-bottom direction Z with respect to the right sheet feeding unit 30R positioned and supported by the right-front frame 302 as described above. Therefore, positional accuracy between the sheet S supported and stored in the right feeding cassette 40R and the right sheet feeding unit 30R is improved, and occurrence of a feeding failure when the sheet S is fed, skew feeding of the sheet, and the like can be reduced. In the present embodiment, the positioning pin 401R fixedly disposed on the right-front frame 302 and the fitting hole 402R fixedly disposed on the main body 41R of the right feeding cassette 40R form a first positioning portion 400R.

As illustrated in FIG. 4, a first abutment portion 500R is disposed on a right side of the fitting hole 402R disposed on the right side of the main body 41R of the right feeding cassette 40R. The first abutment portion 500R includes an abutment plate 501R having an abutment surface 501aR and a long hole 501bR, a fixing screw 502R for fixing the abutment plate 501R to the main body 41R, and an adjustment table 503R for adjusting a position of the abutment plate 501R in the front-rear direction Y. That is, a position of the abutment surface 501aR of the abutment plate 501R in the front-rear direction Y is adjusted as the top-bottom direction Z is adjusted along an inclined surface of the adjustment table 503R, and the abutment plate 501R is fixed by the fixing screw 502R in this state. That is, an inclined surface of the abutment plate 501R, the inclined surface of the adjustment table 503R, the long hole 501bR, and the fixing screw 502R form a first adjustment mechanism that adjusts a position of the right feeding cassette 40R in the front-rear direction Y with respect to the feeding apparatus body 10A at the first mounting position. Then, the abutment surface 501aR of the abutment plate 501R abuts on a front surface of the right-front frame 302 of the frame body 300 in the front-rear direction Y when the right feeding cassette 40R is positioned at the first mounting position and mounted on the feeding apparatus body 10A. In the present embodiment, an adjustment plate 302P is fixed to the front surface of the right-front frame 302, and the abutment surface 501aR abuts on the adjustment plate 302P, which is equivalent to abutting on the front surface of the right-front frame 302.

As described above, when the right feeding cassette 40R is moved rearward from the first separation position where the right feeding cassette 40R is separated from the feeding apparatus body 10A of the printer 100 and moved to the first mounting position, the retraction guide pin 43R is engaged with the retraction unit 600R and is retracted rearward. That is, the retraction unit 600R incorporates the toggle mechanism (not illustrated), and is configured to retract the retraction guide pin 43R inserted into the retraction unit 600R by a certain amount or more. Then, the abutment surface 501aR of the abutment plate 501R abuts on the front surface of the right-front frame 302 while being pressed by a retraction force of the retraction unit 600R. As a result, the right feeding cassette 40R is positioned with respect to the right-front frame 302 in the front-rear direction Y, and is positioned with high accuracy in the front-rear direction Y with respect to the right sheet feeding unit 30R positioned and supported by the right-front frame 302 as described above. In particular, since the right-front frame 302 is a frame member that forms an outer frame of the frame body 300, the right-front frame 302 has a high stiffness and is hardly deformed even in a case where the right feeding cassette 40R is inserted with a strong force, and thus is suitable as a component on which the first abutment portion 500R abuts. Therefore, the positional accuracy between the sheet S supported and stored in the right feeding cassette 40R and the right sheet feeding unit 30R is improved, and it is possible to prevent or reduce the occurrence of a feeding failure when the sheet S is fed, skew feeding of the sheet, a decrease in accuracy of an image forming position, and the like.

### Configuration of Left Feeding Cassette

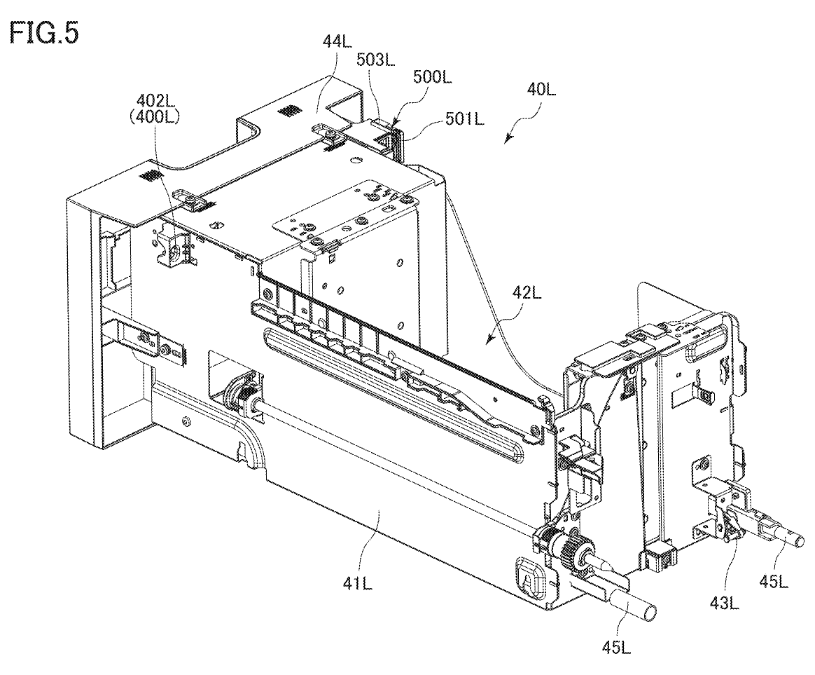

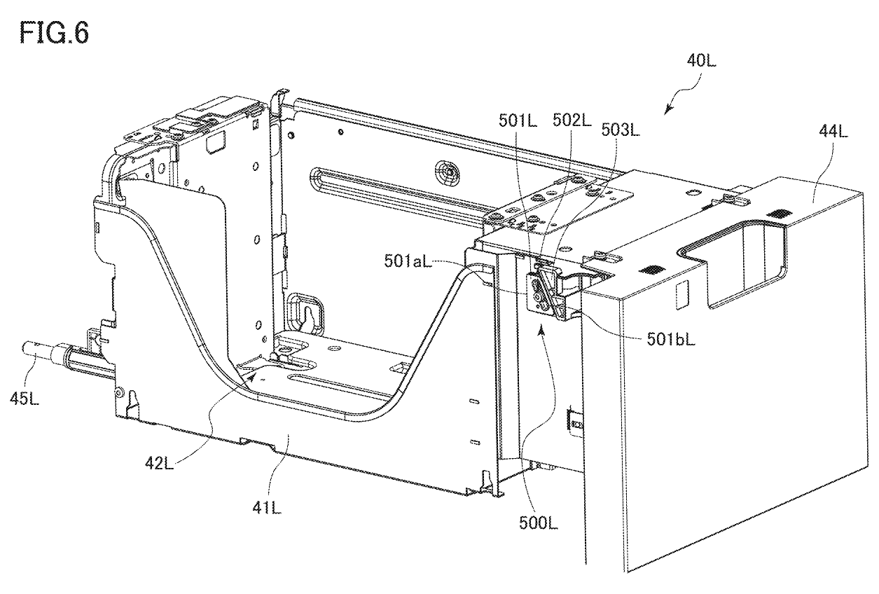

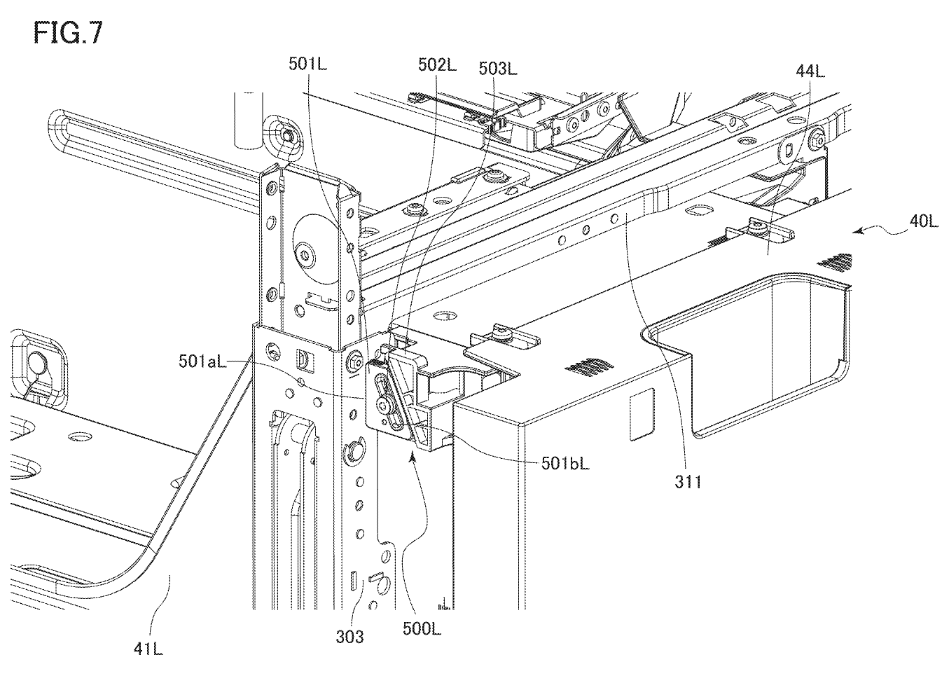

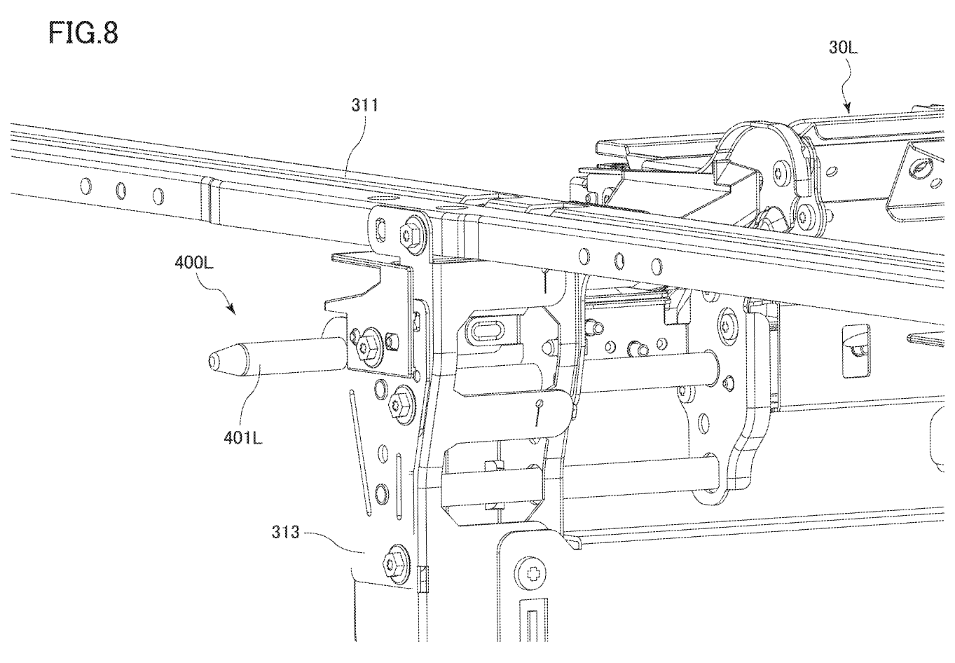

Next, a configuration of the left feeding cassette 40L will be described in detail with reference to FIGS. 5-8. FIG. 5 is a perspective view illustrating the left feeding cassette according to the present embodiment when viewed from the right-rear side. FIG. 6 is a perspective view illustrating the left feeding cassette according to the present embodiment when viewed from a left-front side. FIG. 7 is a perspective view illustrating a state in which the left feeding cassette according to the present embodiment is mounted on the apparatus body when viewed from the left-front side. FIG. 8 is a perspective view illustrating a positioning pin of the left feeding cassette according to the present embodiment when viewed from the right-front side.

As illustrated in FIGS. 5 and 6, the left feeding cassette 40L includes a main body 41L that forms a storage space 42L in which the sheets S are supported. An outer wall portion 44L that forms a part of the outer wall of the printer 100 is fixedly disposed on a front side of the main body 41L in a state in which the left feeding cassette 40L is positioned at the second mounting position and mounted on the feeding apparatus body 10A. The retraction guide pin 43L that is engaged with the retraction unit 600L to retract the left feeding cassette 40L to the feeding apparatus body 10A when the left feeding cassette 40L is moved from the second separation position to the second mounting position is fixedly disposed on a rear side of the main body 41L. Two insertion shafts 45L that are inserted into holes (not illustrated) of the rear plate 306 of the frame body 300 and support the left feeding cassette 40L are fixedly disposed on the rear side of the main body 41L.

A fitting hole 402L serving as a second engaged portion or a second fitting hole is fixedly disposed on a right side of the main body 41L of the left feeding cassette 40L. As illustrated in FIG. 8, a positioning pin 401L serving as a second engaging portion or a second pin fixedly disposed on the intermediate stay 313 of the frame body 300 can be freely fitted into the fitting hole 402L. That is, the positioning pin 401L is fitted into the fitting hole 402L when the left feeding cassette 40L is positioned at the second mounting position and mounted on the feeding apparatus body 10A. As a result, the left feeding cassette 40L is positioned with respect to the intermediate stay 313 in the left-right direction X and the top-bottom direction Z, and is positioned with high accuracy in the left-right direction X and the top-bottom direction Z with respect to the left sheet feeding unit 30L positioned and supported by the intermediate stay 313 as described above. Therefore, positional accuracy between the sheet S supported and stored in the left feeding cassette 40L and the left sheet feeding unit 30L is improved, and occurrence of a feeding failure when the sheet S is fed, skew feeding of the sheet, and the like can be reduced. In the present embodiment, the positioning pin 401L fixedly disposed on the intermediate stay 313 and the fitting hole 402L fixedly disposed on the main body 41L of the left feeding cassette 40L form a second positioning portion 400L.

As illustrated in FIGS. 6 and 7, a second abutment portion 500L is disposed on a left side of the main body 41L of the left feeding cassette 40L. The second abutment portion 500L includes an abutment plate 501L having an abutment surface 501aL and a long hole 501bL, a fixing screw 502L for fixing the abutment plate 501L to the main body 41L, and an adjustment table 503L for adjusting a position of the abutment plate 501L in the front-rear direction Y. That is, a position of the abutment surface 501aL of the abutment plate 501L in the front-rear direction Y is adjusted as the top-bottom direction Z is adjusted along an inclined surface of the adjustment table 503L, and the abutment plate 501L is fixed by the fixing screw 502L in this state. That is, an inclined surface of the abutment plate 501L, the inclined surface of the adjustment table 503L, the long hole 501bL, and the fixing screw 502L form a second adjustment mechanism that adjusts a position of the left feeding cassette 40L in the front-rear direction Y with respect to the feeding apparatus body 10A at the second mounting position. Then, as illustrated in FIG. 7, the abutment surface 501aL of the abutment plate 501L abuts on a front surface of the left-front frame 303 of the frame body 300 in the front-rear direction Y when the left feeding cassette 40L is positioned at the second mounting position and mounted on the feeding apparatus body 10A.

Here, for example, it is assumed that the left feeding cassette 40L is configured similarly to the right feeding cassette 40R described above, that is, the second abutment portion 500L is disposed on a right side of the second fitting hole 402L disposed on the right side of the main body 41L of the left feeding cassette 40L. In this case, the second abutment portion 500L abuts on the intermediate stay 313. However, the intermediate stay 313 supported via the upper-front stay 311 and the lower-front stay 312 with respect to the right-front frame 302 and the left-front frame 303 forming the outer frame of the frame body 300 has a lower stiffness than the right-front frame 302 and the left-front frame 303. Therefore, in a case where the left feeding cassette 40L is inserted with a strong force, deformation is likely to occur, and there is a possibility that the left feeding cassette 40L is shifted from the second mounting position when inserted into the feeding apparatus body 10A. On the other hand, in the present embodiment, the second abutment portion 500L is disposed on the left side of the left feeding cassette 40L and abuts on the left-front frame 303, and thus, the left-front frame 303 is hardly deformed, and positioning accuracy of the left feeding cassette 40L is improved.

Specifically, when the left feeding cassette 40L is moved rearward from the second separation position where the left feeding cassette 40L is separated from the feeding apparatus body 10A of the printer 100 as described above and moved to the second mounting position, the retraction guide pin 43L is engaged with the retraction unit 600L and is retracted rearward. That is, the retraction unit 600L incorporates the toggle mechanism (not illustrated), and is configured to retract the retraction guide pin 43L inserted into the retraction unit 600L by a certain amount or more. Then, the abutment surface 501aL of the abutment plate 501L abuts on the front surface of the left-front frame 303 while being pressed by a retraction force of the retraction unit 600L. As a result, the left feeding cassette 40L is positioned with respect to the left-front frame 303 in the front-rear direction Y, and is positioned with high accuracy in the front-rear direction Y with respect to the left sheet feeding unit 30L positioned and supported by the frame body 300 as described above. In particular, since the left-front frame 303 is a frame member that forms the outer frame of the frame body 300, the left-front frame 303 has a high stiffness and is hardly deformed even in a case where the left feeding cassette 40L is inserted with a strong force, and thus is suitable as a component on which the second abutment portion 500L abuts. Therefore, the positional accuracy between the sheet S supported and stored in the left feeding cassette 40L and the left sheet feeding unit 30L is improved, and it is possible to prevent or reduce the occurrence of a feeding failure when the sheet S is fed, skew feeding of the sheet, a decrease in accuracy of the image forming position, and the like.

### Configuration of Lower Feeding Cassette

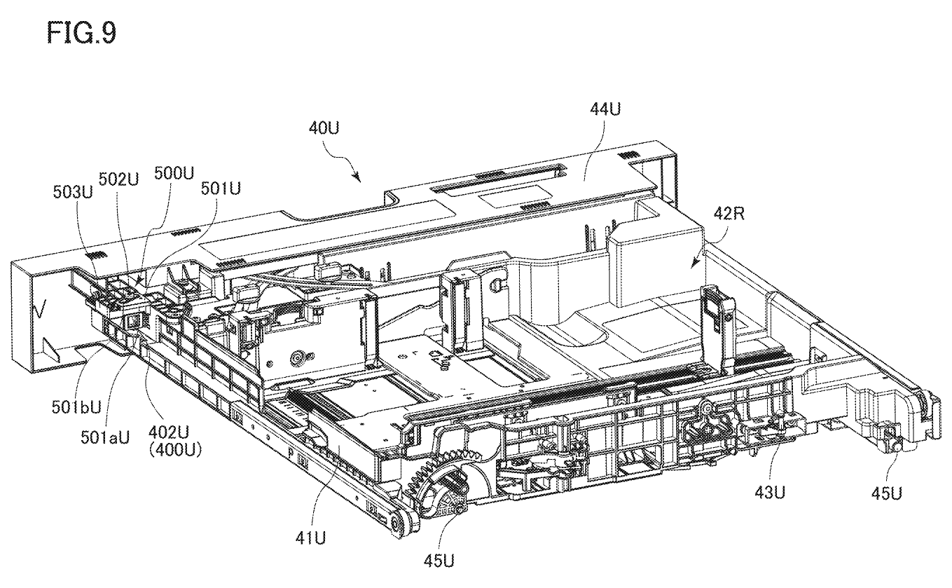

Next, a configuration of the lower feeding cassette 40U will be described in detail with reference to FIG. 9. FIG. 9 is a perspective view illustrating the lower feeding cassette according to the present embodiment when viewed from the right-rear side.

As illustrated in FIG. 9, the lower feeding cassette 40U includes a main body 41U that forms a storage space 42U in which the sheets S are supported. An outer wall portion 44U that forms a part of the outer wall of the printer 100 is fixedly disposed on a front side of the main body 41U in a state in which the lower feeding cassette 40U is positioned at the third mounting position and mounted on the feeding apparatus body 10A. The retraction guide pin 43U that is engaged with the retraction unit 600U to retract the lower feeding cassette 40U to the feeding apparatus body 10A when the lower feeding cassette 40U is moved from the third separation position to the third mounting position is fixedly disposed on a rear side of the main body 41U. Two insertion shafts 45U that are inserted into holes (not illustrated) of the rear plate 306 of the frame body 300 and support the lower feeding cassette 40U are fixedly disposed on the rear side of the main body 41U.

A fitting hole 402U serving as a third engaged portion or a third fitting hole is fixedly disposed on a right side of the main body 41U of the lower feeding cassette 40U. A positioning pin 401U (see FIG. 2) serving as a third engaging portion or a third pin fixedly disposed on the right-front frame 302 of the frame body 300 can freely be fitted into the fitting hole 402U. That is, the positioning pin 401U is fitted into the fitting hole 402U when the lower feeding cassette 40U is positioned at the third mounting position and mounted on the feeding apparatus body 10A. As a result, the lower feeding cassette 40U is positioned with respect to the right-front frame 302 in the left-right direction X and the top-bottom direction Z, and is positioned with high accuracy in the left-right direction X and the top-bottom direction Z with respect to the lower sheet feeding unit 30U positioned and supported by the right-front frame 302 as described above. Therefore, positional accuracy between the sheet S supported and stored in the lower feeding cassette 40U and the lower sheet feeding unit 30U is improved, and occurrence of a feeding failure when the sheet S is fed, skew feeding of the sheet, and the like can be reduced. In the present embodiment, the positioning pin 401U fixedly disposed on the right-front frame 302 and the fitting hole 402U fixedly disposed on the main body 41U of the lower feeding cassette 40U form a third positioning portion 400U.

As illustrated in FIG. 4, a third abutment portion 500U is disposed on a right side of the fitting hole 402U disposed on the right side of the main body 41U of the lower feeding cassette 40U. The third abutment portion 500U includes an abutment plate 501U having an abutment surface 501aU and a long hole 501bU, a fixing screw 502U for fixing the abutment plate 501U to the main body 41U, and an adjustment table 503U for adjusting a position of the abutment plate 501U in the front-rear direction Y. That is, a position of the abutment surface 501aU of the abutment plate 501U in the front-rear direction Y is adjusted as the top-bottom direction Z is adjusted along an inclined surface of the adjustment table 503U, and the abutment plate 501U is fixed by the fixing screw 502U in this state. That is, an inclined surface of the abutment plate 501U, the inclined surface of the adjustment table 503U, the long hole 501bU, and the fixing screw 502U form a third adjustment mechanism that adjusts a position of the lower feeding cassette 40U in the front-rear direction Y with respect to the feeding apparatus body 10A at the third mounting position. Then, the abutment surface 501aU of the abutment plate 501U abuts on a front surface of the right-front frame 302 of the frame body 300 in the front-rear direction Y when the lower feeding cassette 40U is positioned at the third mounting position and mounted on the feeding apparatus body 10A.

As described above, when the lower feeding cassette 40U is moved rearward from the third separation position where the lower feeding cassette 40U is separated from the feeding apparatus body 10A of the printer 100 and moved to the third mounting position, the retraction guide pin 43U is engaged with the retraction unit 600U and is retracted rearward. That is, the retraction unit 600U incorporates the toggle mechanism (not illustrated), and is configured to retract the retraction guide pin 43U inserted into the retraction unit 600U by a certain amount or more. Then, the abutment surface 501aU of the abutment plate 501U abuts on the front surface of the right-front frame 302 while being pressed by a retraction force of the retraction unit 600U. As a result, the lower feeding cassette 40U is positioned with respect to the right-front frame 302 in the front-rear direction Y, and is positioned with high accuracy in the front-rear direction Y with respect to the lower sheet feeding unit 30U positioned and supported by the right-front frame 302 as described above. In particular, since the right-front frame 302 is a frame member that forms the outer frame of the frame body 300, the right-front frame 302 has a high stiffness and is hardly deformed even in a case where the lower feeding cassette 40U is inserted with a strong force, and thus is suitable as a component on which the third abutment portion 500U abuts. Therefore, the positional accuracy between the sheet S supported and stored in the lower feeding cassette 40U and the lower sheet feeding unit 30U is improved, and it is possible to prevent or reduce the occurrence of a feeding failure when the sheet S is fed, skew feeding of the sheet, a decrease in accuracy of the image forming position, and the like.

### Possibility of Other Embodiments

In the present embodiment described above, the lower feeding cassette 40U is provided below the right feeding cassette 40R and the left feeding cassette 40L, but the present technology is not limited thereto, and the lower feeding cassette 40U does not have to be provided. In this case, in the frame body 300, the lower-front stay 312 may be eliminated, and the intermediate stay 313 may span between the upper-front stay 311 and the lower plate 301.

In the present embodiment, only one lower feeding cassette 40U is provided below the right feeding cassette 40R and the left feeding cassette 40L, but the number of lower feeding cassettes 40U is not limited thereto. Two or more lower feeding cassettes 40U may be provided.

In the present embodiment, the right sheet feeding unit 30R is disposed on the right-front frame 302, but the position of the right sheet feeding unit 30R is not limited thereto. The right sheet feeding unit 30R may be disposed at any position according to a structure of the image forming unit 20, for example. For example, the right sheet feeding unit 30R may be disposed on the intermediate stay 313.

In the present embodiment, the left sheet feeding unit 30L is disposed on the intermediate stay 313, but the position of the left sheet feeding unit 30L is not limited thereto. The left sheet feeding unit 30L may be disposed at any position according to the structure of the image forming unit 20, for example. For example, the left sheet feeding unit 30L may be disposed on the left-front frame 303.

In the present embodiment, the lower sheet feeding unit 30U is disposed on the right-front frame 302, but the position of the lower sheet feeding unit 30U is not limited thereto. The lower sheet feeding unit 30U may be disposed at any position according to the structure of the image forming unit 20, for example. For example, the lower sheet feeding unit 30U may be disposed on the left-front frame 303.

In the present embodiment, a case where the positioning pin 401R of the first positioning portion 400R is disposed on the right-front frame 302, and the fitting hole 402R is disposed on the right side of the main body 41R of the right feeding cassette 40R has been described. However, the position of the first positioning portion 400R is not limited thereto, and the first positioning portion 400R may be disposed at any position. For example, the positioning pin 401R of the first positioning portion 400R may be disposed on the intermediate stay 313, and the fitting hole 402R may be disposed on a left side of the main body 41R of the right feeding cassette 40R.

Similarly, in the present embodiment, a case where the positioning pin 401L of the second positioning portion 400L is disposed on the intermediate stay 313, and the fitting hole 402L is disposed on the right side of the main body 41L of the left feeding cassette 40L has been described. However, the position of the second positioning portion 400L is not limited thereto, and the second positioning portion 400L may be disposed at any position. For example, the positioning pin 401L of the second positioning portion 400L may be disposed on the left-front frame 303, and the fitting hole 402L may be disposed on a left side of the main body 41L of the left feeding cassette 40L.

Similarly, in the present embodiment, a case where the positioning pin 401U of the third positioning portion 400U is disposed on the right-front frame 302, and the fitting hole 402U is disposed on the right side of the main body 41U of the lower feeding cassette 40U has been described. However, the position of the third positioning portion 400U is not limited thereto, and the third positioning portion 400U may be disposed at any position. For example, the positioning pin 401U of the third positioning portion 400U may be disposed on the left-front frame 303, and the fitting hole 402L may be disposed on a left side of the main body 41U of the lower feeding cassette 40U.

In the present embodiment, a case where each of the first positioning portion 400R, the second positioning portion 400L, and the third positioning portion 400U is formed by the positioning pin and the fitting hole has been described. However, the structure of each of the first positioning portion 400R, the second positioning portion 400L, and the third positioning portion 400U is not limited thereto, and any structure may be used as long as each feeding cassette at the mounting position can be positioned in the left-right direction X and the top-bottom direction Z with respect to the feeding apparatus body 10A.

In the present embodiment, a case where the adjustment mechanism is formed by the inclined surface of the abutment plate, the inclined surface of the adjustment table, the long hole, and the fixing screw in the first abutment portion 500R, the second abutment portion 500L, and the third abutment portion 500U has been described. However, the structure of the adjustment mechanism is not limited thereto, and any structure may be used as long as the position of each feeding cassette at the mounting position in the front-rear direction Y can be adjusted.

Further, in the present embodiment, a case where the first direction is the front-rear direction, the second direction is the left-right direction, and the third direction is the top-bottom direction has been described. However, the first to third directions are not limited thereto and may be any directions. For example, each feeding cassette can be attached and detached by moving in the left-right direction.

In the present embodiment, a case where the sheet feeding apparatus is applied to the printer 100 (image forming apparatus) has been described, but the application of the sheet feeding apparatus is not limited thereto. For example, the sheet feeding apparatus of the present embodiment may be used in any apparatus such as a large-capacity deck externally attached to the image forming apparatus. Further, the present technology is not limited to an apparatus including the sheet feeding apparatus, and may be applied to an apparatus that itself can be regarded as the sheet feeding apparatus.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-024123, filed Feb. 18, 2025, which is hereby incorporated by reference herein in its entirety.

What is claimed is:

1. A sheet feeding apparatus comprising:
an apparatus body including a first feeding unit configured to feed a sheet, a second feeding unit configured to feed a sheet, and a frame body;
a first storage unit configured to store the sheet to be fed by the first feeding unit and move in a first direction between a first mounting position where the first storage unit is mounted on the apparatus body and a first separation position where the first storage unit is separated from the apparatus body; and
a second storage unit configured to store the sheet to be fed by the second feeding unit and move in the first direction between a second mounting position where the second storage unit is mounted on the apparatus body and a second separation position where the second storage unit is separated from the apparatus body, the second storage unit being arranged side by side with the first storage unit in a second direction orthogonal to the first direction,
wherein
the frame body includes:
a first frame disposed on a side of the first storage unit that is opposite to the second storage unit in the second direction and disposed with a third direction orthogonal to the first direction and the second direction as a longitudinal direction thereof, and
a second frame disposed on a side of the second storage unit that is opposite to the first storage unit in the second direction and disposed with the third direction as a longitudinal direction thereof,
the first storage unit includes a first abutment portion configured to abut on the first frame in the first direction at the first mounting position, and
the second storage unit includes a second abutment portion configured to abut on the second frame in the first direction at the second mounting position.

2. The sheet feeding apparatus according to claim 1, further comprising a support member extending in the third direction between the first storage unit and the second storage unit in the second direction,
wherein the first feeding unit is supported by the first frame, and
the second feeding unit is supported by the support member.

3. The sheet feeding apparatus according to claim 2, wherein
the frame body includes:
a first cross member disposed with the second direction as a longitudinal direction thereof on one sides of the first storage unit and the second storage unit in the third direction, and spanning between the first frame and the second frame, and
a second cross member disposed with the second direction as a longitudinal direction thereof on other sides of the first storage unit and the second storage unit in the third direction, and spanning between the first frame and the second frame, and
the support member is disposed with the third direction as a longitudinal direction thereof and spans between the first cross member and the second cross member.

4. The sheet feeding apparatus according to claim 3, further comprising:
a first positioning portion including a first engaging portion disposed on one of the first frame and the first storage unit and a first engaged portion disposed on the other of the first frame and the first storage unit, and configured to position the first storage unit with respect to the first frame in the second direction and the third direction in a case where the first storage unit is positioned at the first mounting position, and
a second positioning portion including a second engaging portion disposed on one of the support member and the second storage unit and a second engaged portion disposed on the other of the support member and the second storage unit, and configured to position the second storage unit with respect to the support member in the second direction and the third direction in a case where the second storage unit is positioned at the second mounting position.

5. The sheet feeding apparatus according to claim 4, wherein
the first engaging portion is a first pin fixed to the first frame and extending in the first direction,
the first engaged portion is a first fitting hole formed in the first storage unit and into which the first pin is fitted,
the second engaging portion is a second pin fixed to the support member and extending in the first direction, and
the second engaged portion is a second fitting hole formed in the second storage unit and into which the second pin is fitted.

6. The sheet feeding apparatus according to claim 1, wherein
the apparatus body includes:
a first retractor configured to retract the first storage unit to the first mounting position in a case where the first storage unit is moved from the first separation position to the first mounting position, and press the first abutment portion against the first frame in a state in which the first storage unit is positioned at the first mounting position, and
a second retractor configured to retract the second storage unit to the second mounting position in a case where the second storage unit is moved from the second separation position to the second mounting position, and press the second abutment portion against the second frame in a state in which the second storage unit is positioned at the second mounting position.

7. The sheet feeding apparatus according to claim 1, wherein
the first abutment portion includes a first adjustment mechanism configured to adjust a position of the first storage unit in the first direction with respect to the apparatus body at the first mounting position, and
the second abutment portion includes a second adjustment mechanism configured to adjust a position of the second storage unit in the first direction with respect to the apparatus body at the second mounting position.

8. The sheet feeding apparatus according to claim 1, wherein
the apparatus body includes a third feeding unit configured to feed a sheet,
the sheet feeding apparatus further comprises a third storage unit configured to store the sheet to be fed by the third feeding unit and move in the first direction between a third mounting position where the third storage unit is mounted on the apparatus body and a third separation position where the third storage unit is separated from the apparatus body, the third storage unit being arranged side by side with the first storage unit in the third direction, and
the third storage unit includes a third abutment portion configured to abut on the first frame in the first direction at the third mounting position.

9. The sheet feeding apparatus according to claim 8, wherein the third feeding unit is supported by the first frame.

10. The sheet feeding apparatus according to claim 9, further comprising a third positioning portion including a third engaging portion disposed on one of the first frame and the third storage unit and a third engaged portion disposed on the other of the first frame and the third storage unit, and configured to position the third storage unit with respect to the first frame in the second direction and the third direction in a case where the third storage unit is positioned at the third mounting position.

11. The sheet feeding apparatus according to claim 10, wherein
the third engaging portion is a third pin fixed to the first frame and extending in the first direction, and
the third engaged portion is a third fitting hole formed in the third storage unit and into which the third pin is fitted.

12. The sheet feeding apparatus according to claim 8, wherein the apparatus body includes
a third retractor configured to retract the third storage unit to the third mounting position in a case where the third storage unit is moved from the third separation position to the third mounting position, and press the third abutment portion against the first frame in a state in which the third storage unit is positioned at the third mounting position.

13. The sheet feeding apparatus according to claim 8, wherein the third abutment portion includes a third adjustment mechanism configured to adjust a position of the third storage unit in the first direction with respect to the apparatus body at the third mounting position.

14. The sheet feeding apparatus according to claim 1, wherein
the first direction is a front-rear direction,
the second direction is a left-right direction, and
the third direction is a top-bottom direction.

15. The sheet feeding apparatus according to claim 1, wherein the first frame and the second frame form an outer frame of the frame body.

16. An image forming apparatus comprising:
the sheet feeding apparatus according to claim 1; and
an image forming unit configured to form an image on a sheet.
